(19) United States
(12) Patent Application Publication
(10) Pub. No.: US 2013/0340537 A1
(43) Pub. Date: Dec. 26, 2013

(54) FORCE SENSOR INCLUDING SENSOR PLATE WITH LOCAL DIFFERENCES IN STIFFNESS

(71) Applicant: TECSIS GmbH, Offenbach (DE)

(72) Inventors: Florian Freiwald, Babenhausen (DE); Oliver Jost, Langen (DE); Markus Muller, Darmstadt (DE)

(21) Appl. No.: 13/917,271

(22) Filed: Jun. 13, 2013

(30) Foreign Application Priority Data
Jun. 14, 2012 (DE) 102012210021.0

(51) Int. Cl. G01L 1/22

(52) U.S. Cl. CPC G01L 1/2287
USPC 73/862.045; 73/862.627

(57) ABSTRACT

A force sensor for measuring forces comprises a sensor plate where at least one measuring resistor is arranged whereby deformations of the sensor plate can be detected as a result of forces to be measured. The sensor plate includes at least one local weakened area whereby deformation behavior of the sensor plate is influenced. The weakened area results in bypassing the flux of force in the sensor plate and in concentrating the forces at non-weakened portions of the sensor plate. The at least one measuring resistor is preferably arranged at such non-weakened deforming portion of the sensor plate. The at least one weakened area defines sensor plate portions separated from at least in sections, the sensor plate portions being exposed to opposite forces. The sensor plate can be mounted in a housing with an evaluation circuit, for example, and constitute a force sensor having compact dimensions and high measuring sensitivity.

### CROSS-REFERENCE TO RELATED APPLICATION

This application claims priority to foreign German patent application No. DE 102012210021.0, filed on Jun. 14, 2012, the disclosure of which is incorporated by reference in its entirety.

### FIELD OF THE INVENTION

The invention relates to a force sensor for measuring forces, wherein the force sensor makes use of a sensor plate on which at least one measuring resistor is arranged. The sensor plate is slightly deformed by the applied forces to be measured and the deformation of the sensor plate influences the value of the measuring resistor. Thus the magnitude and the direction of the forces acting on the sensor plate can be concluded from the value of the measuring resistor so that a force sensor is obtained in this way.

Preferably plural measuring resistors are arranged on a sensor plate, wherein a bridge circuit is used to accurately measure the resistance values of the measuring resistors. Preferably the forces can be concluded from the resistance readings by way of a calibrating curve taken up or calculated before.

### BACKGROUND

From the state of the art an application is known in which a force sensor is formed in that a sensor plate consisting of a metal wafer including measuring resistors applied thereto is welded into the hole of a metal body which is preferably in the form of an elongate metallic plate having such hole. The forces to be measured are applied to the two free ends of the metal plate, whereby the resulting slight deformation of the plate propagates to the sensor wafer and there results in the variation of the resistance readings. The forces are concluded from said readings.

The known arrangement has the drawback, however, that for a reasonable practical application a minimum stability of the plate-shaped metal body supporting the sensor wafer has to be given, which naturally impairs the measuring sensitivity of said known force sensor.

### SUMMARY OF THE INVENTION

Compared to this, it is the object of the invention to suggest a force sensor for measuring small forces.

This object is achieved by a force sensor comprising the features of claim 1.

In accordance with the invention, a force sensor for measuring forces is provided comprising a sensor plate at which at least one measuring resistor is arranged and by which deformations of the sensor plate can be detected by forces to be measured. The sensor plate has at least one local weakening area influencing the deformation behavior of the sensor plate.

Hence it is provided according to the invention to design a sensor plate in such way that it is not a uniform plate but has weakened areas by which the deformation behavior of the sensor plate can be influenced. It is especially taken into account to concentrate the deformations on non-weakened portions by forming the weakened areas so that no or only small forces can be transmitted there. This can be achieved in particular by the fact that in the sensor plate are provided cut-outs or recesses through which naturally no forces can be transmitted.

Preferably the measuring resistor is arranged at a deforming portion of the sensor plate which is different from the weakened area. In this way the measuring resistor is placed where the flux of force is concentrated, i.e. the measuring resistor is arranged at a position where the deformation to be expected is high.

Preferably sensor plate portions separated from each other by a weakened area are interconnected by a land operatively connected to the measuring resistor. Such operative connection can be such that the measuring resistor or the measuring resistors are arranged on the land itself. The operative connection can also be such that the measuring resistor or the measuring resistors are arranged in the root area of the land and further on the respective sensor plate portions so that the measuring resistors are arranged already in a section of the sensor plate where the tensions are concentrated and thus the deformations are more significant.

The weakened areas in the sensor plate of the force sensor preferably can be plate cut-outs or else portions of thinner plate material, with combinations of said two configurations being possible as well, as a matter of course. Preferably the sensor plate will have breakthroughs, as they can be manufactured more easily. However, it is possible, by appropriate methods, to abrade parts of the sensor plate in the direction of thickness without forming breakthroughs. This may be interesting, for example, when the sensor plate itself has to further entail a sealing function, e.g. when its marginal side is welded to a housing.

Preferably the forces to be measured are opposite forces acting on the sensor plate, wherein the local weakening is to be arranged between those areas in which the opposite forces act on the sensor plate. It is ensured in this way that the difference between the opposite forces is concentrated at a position of the sensor plate at which the force transmission is possible, while the weakened areas or cut-outs are hardly involved in the force transmission. In this way the measuring sensitivity, i.e. the measurability of smaller forces, can be obtained by the sensor plate.

Preferably or in a preferred embodiment of the invention the sensor plate is subdivided by the weakened area into a marginal or outer portion and a central portion, said two portions being connected by at least one land and said portions being those areas in which the opposite forces are acting, wherein one or more measuring resistors can be arranged on the land or in root areas of the land, thereby the force being measured in the area of the largest deformation of the sensor plate. Both the outer portion and the central portion can be provided with additional weakened areas.

In a configuration of the invention at least two weakened areas are arranged so that they intersect a straight line extending from the center of the sensor plate to its outer rim. A possibility of realizing this consists in arranging the weakened areas in concentric incomplete circle segments or straight lines on a sensor plate of circular disk shape so that areas are formed in which the weakened areas are overlapping viewed in radial direction, wherein non-weakened land portions interconnecting the non-weakened plate portions are retained.

The sensor plate is preferably used in a form in which it detects opposite forces acting on a central portion and oppositely on a marginal or outer portion separated in sections from the central portion by weakened areas. At the marginal side the sensor plate can be clamped in a housing and with its central portion can be associated with a force application portion or coupling member kept movable vis-à-vis the housing. In this case the opposite forces to be measured are applied vertically or obliquely with respect to the plane of the plate so that the deformation of the sensor plate is concentrated at the non-weakened portions between the weakened areas. In this area the measuring resistors are preferably arranged so that a precise measurement of even small forces is possible. In the described arrangement the outer portion of the sensor plate is supported and the central portion is adapted to be connected to coupling members for launching the forces to be measured. The support can be performed at a housing, while as a coupling member a disk movably supported relative to the housing is used which disk has an extension connected to the central portion of the sensor plate. The movable bearing of the coupling member relative to the housing can also be achieved by elastically deformable parts such as rubber inserts or the like. The coupling member can support a connecting part such as a threaded extension.

Preferably the sensor plate has a threefold radial symmetry. The sensor plate can have three equally shaped lands mutually enclosing a respective angle of 120°. In addition or alternatively the marginal portion can have three fastening points by which the sensor plate is fastened to the acceptance. These fastening points can mutually enclose a respective angle of 120° and in a preferred manner can be disposed centrally between two lands. Thus proportionality is given between the measured signals and the partial loads applied to the marginal portion at the three fastening points.

In an advantageous configuration of the invention the sensor plate is a circular disk. However, it is also possible to manufacture the sensor plate in a different design, wherein it has to be considered that the configuration of a housing or an acceptance for supporting the sensor plate can be manufactured more easily with a circular shape.

The sensor plate preferably has a base portion and a projecting portion extending away therefrom and being restricted by weakened areas. In the projecting portion the at least one measuring resistor is arranged and the portions of action, i.e. the area in which the forces to be measured are applied to the sensor plate, are portions formed by the base portion and the end of the projecting portion facing away from the base portion.

For instance, the base portion is a circular ring from which plural arms extend spoke-like to the center of the circular ring as the projecting portions including measuring resistors thereon. The arm-shaped projecting portions can end in the center of the circular ring with free ends or they can be connected like a hub to form a joint portion of application for the force to be measured.

The plural measuring resistors can be connected by bridge circuits and can be linked with evaluation circuit. The bridge circuit is a connection of resistors also referred to as Wheatstone's bridge. This circuit is known per se and need not be explained in detail. It is important that resistance values can be measured very exactly by said bridge circuit.

If plural measuring resistors are used, especially when plural measuring resistors on different portions of the sensor plate are used, not only a pair of forces/counter-forces vertical with respect to the plate can be measured, but also the direction of force and the place of force application related to the center of the sensor plate can be separately detected and concluded. The sensor plate is preferably designed, in particular the weakened areas are selected such that forces in the range of 10N to 1000N generate sufficient variations of the values of the measuring resistors so that those forces can be detected reliably and exactly in this range.

Especially an application for determining a force vector by means of a plate-shaped sensor having a number of weakened areas and plural measuring resistors mounted in connection with the weakened areas is provided. The sensor first provides individual signals of the respective measuring resistors which then can be offset against each other so that the amount and the direction or the amount and the coupling point (location) of the force vector is obtained from the individual signals. The respective calculating case, namely the calculation of the direction and the amount or the location and the amount results from the situation of application of the sensor. If the force is applied to a fixed point of the sensor plate, the amount and the direction of the force sensor can be concluded from the individual signals of the measuring resistors. If, however, the force is transmitted to the sensor plate via a sliding ball or the like, for instance, without transverse forces being adapted to be transmitted, the amount and the location of the force application can be determined normal to the plane of the sensor plate.

Preferably the force vector is determined as regards the amount and the direction or as regards the amount and the location via a vector addition of the individual signals or by way of a matrix equation based on the individual measuring resistor positions in a cylinder coordinate system and the associated individual signals.

Preferably the sensor plate and/or a housing receiving the sensor plate and/or the coupling member(s) is/are made of stainless steel.

The measuring resistors arranged on the sensor plate can be resistors applied in thin-film technique.

A possible method of manufacturing the force sensor according to the invention for the measurement of forces provides that the sensor plate is provided with weakened areas according to the afore-described type after the measuring resistors have been applied by thin-film technique. In this way sensor plates provided with measuring resistors by thin-film technique according to a conventional method can be subsequently adapted to the measuring task by introducing appropriate cut-outs or weakened areas to the sensor plates. Possible methods for this could be water-jet cutting or laser cutting. It is also possible to form weakened areas in the sensor plate with the aid of eroding methods or etching methods.

### BRIEF DESCRIPTION OF THE DRAWINGS

Hereinafter the invention will be explained in detail by way of preferred embodiments with reference to the drawings in which

FIG. 1 shows a schematized sectional view across an embodiment of the force sensor;

FIG. 2 shows an embodiment of a sensor plate in a top view;

FIG. 3 shows the sensor plate according to FIG. 2 in a perspective view;

FIG. 4 shows another embodiment of a sensor plate for the force sensor according to FIG. 1;

FIG. 5 is another embodiment of a sensor plate for a force sensor;

FIG. 6 is another embodiment for a sensor plate for a force sensor;

FIG. 7 is another embodiment for a sensor plate for a force sensor;

FIG. 8 shows alternative configurations of recesses in a sensor plate as further embodiments;

FIG. 9 is a lateral external view of an embodiment of a force sensor; and

FIG. 10 is a schematized representation of a further embodiment of a force sensor with forces acting on the force sensor; and

FIG. 11 shows a coordinate system for explaining the calculation of the position coordinates of a position of force application from the readings of the sensors.

### DETAILED DESCRIPTION

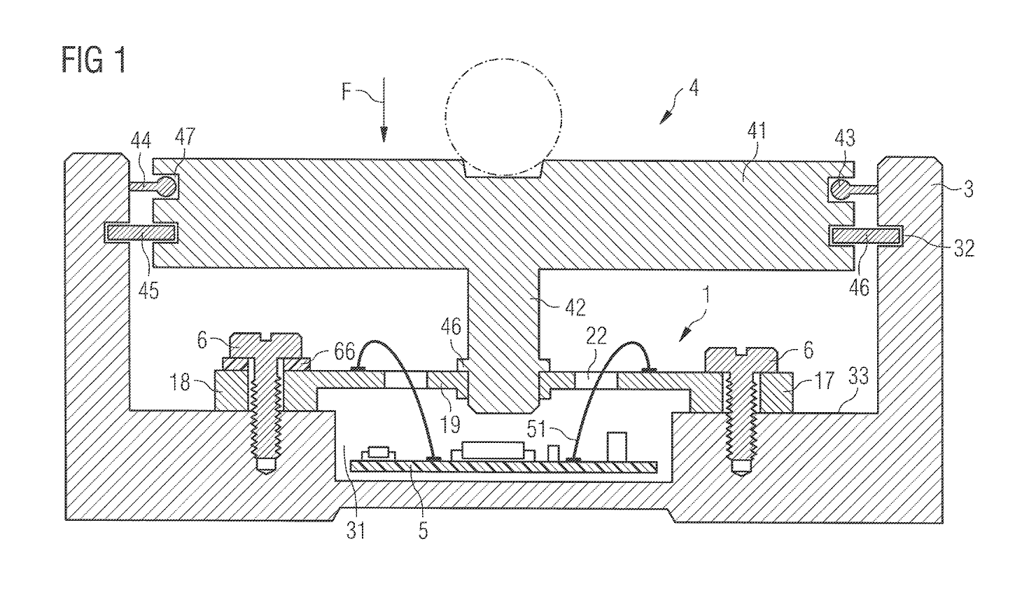

FIG. 1 shows a first embodiment for a force sensor in a sectional view. The force sensor shown in FIG. 1 has a cup-shaped housing 3 receiving a sensor plate 1 as well as a coupling member 4 in its interior. At the inner circumference of the wall portion of the cup-shaped housing 3 a circumferential groove 32 is formed into which a ring 45 engaging in a circumferential groove 46 of the coupling member 4 can be inserted. Both the groove 32 and the circumferential groove 46 are provided with sufficient play so that the coupling member 4 can move in a downward direction in FIG. 1. The inserted ring 45 serves as stop element preventing destruction of a sensor plate 1 coupled to the coupling member 4. The coupling member 4 includes a circumferential groove 47 formed above the circumferential groove 46 in which a seal 43 is accommodated. The seal 43 is made of an elastomer and includes a sealing lip 44 projecting in the circumferential direction which is in sealing contact with the wall of the cup-shaped housing 3. The seal 43 is designed to allow for sufficient movement of the coupling member 4 relative to the housing 3. Alternatively, the seal can also be in the form of a bellow being fixedly connected to the respective element (housing/coupling member) at both of its circumferential edges.

The coupling member 4 is a circular disk 41 comprising a central projection 42 that in turn has an annular collar 46 adapted to be brought into contact with the sensor plate 1.

Inside the cup-shaped housing 3, i.e. in the area of the “cup bottom” a bottom area 33 is provided with a recess 31. The recess 31 is adapted to receive an evaluation board 5 on which electronic parts and wires not described in detail are arranged that are adapted to detect and evaluate resistance values of measuring resistors and to output the result to the outside via a connecting set-up not shown.

As is shown in FIG. 1, a sensor plate 1 is arranged on the bottom area 33 while closing the recess 31. The sensor plate 1 includes a rim portion 18 and a central portion 19 which are separated from each other in sections by weakened areas 22. The weakened areas 22 are slits in the sensor plate 1 that shall be explained in detail hereinafter.

In the circumferential area of the sensor plate 1 a marginal reinforcement 17 is formed by which in the mounted state the sensor plate 1 rests on the bottom area 33 of the housing 3. The sensor plate 1 and the marginal reinforcement 17 are pierced in the marginal portion 18 and screws 6 being screwed into the housing 3 fix the sensor plate 1 at the bottom area 33 of the housing 3. As an alternative, as is shown on the left side in FIG. 1, an intermediate ring 66 penetrated by the screw 6 can be used. This intermediate ring 66 on the one hand distributes the fastening forces to a larger area of the marginal portion 18 of the sensor plate 1 and moreover permits to configure the sensor plate to have notches open to the marginal side for fastening. By generously dimensioned notches it is possible to prevent undesired tensionings in the sensor plate 1 by screw-fixing.

In the arrangement shown in FIG. 1 the measuring resistors (not shown) are arranged on the upper side of the sensor plate 1. In this case the weakened areas 22 in the form of breakthroughs can be used for guiding the wires 51 between the measuring resistors and the evaluation circuit 5.

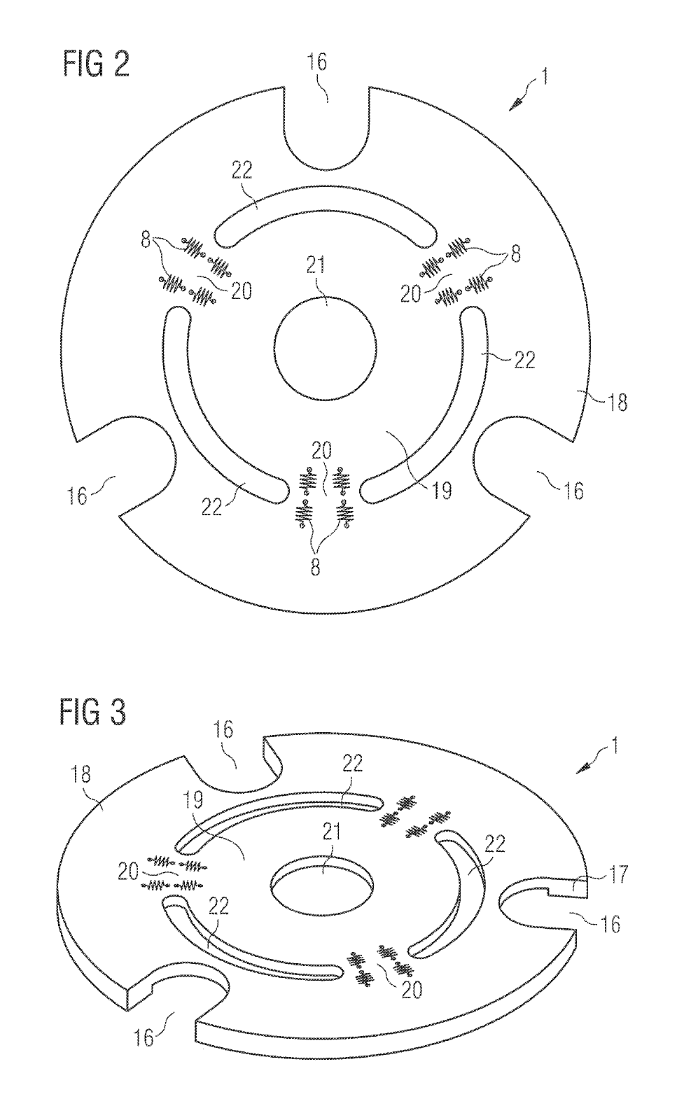

FIG. 2 illustrates an embodiment of the sensor plate 1 that can be mounted, for instance, in the force sensor according to FIG. 1. The sensor plate 1 is a circular disk which at its periphery has formed notches 16 through which fastening elements (not shown) are adapted to be guided so as to be able to fix the sensor plate 1 to a housing (not shown). Furthermore in FIG. 2 it is clearly visible that a marginal portion 18 supporting the notches 16 is separated in sections from the central portion 19 by slits 22 as weakened areas. In the center the sensor plate 1 further includes a hole 21 dimensioned so that a coupling member (not shown) cannot act hereon.

Those portions of the sensor plate 1 at which the marginal portion 18 and the central portion 19 are connected to each other are referred to as land and are denoted with reference numeral 20 in FIG. 2. In the arrangement according to FIG. 2 the sensor plate 1 has three lands 20. The lands are arranged in an equal angular division of 120° in this case; thus the symmetry is advantageous for the evaluation. Measuring resistors 8 are arranged on the lands 20; in FIG. 2 two pairs of measuring resistors 8 are arranged for each land 20. The shown arrangement of the measuring resistors 8 on the lands 20 is only exemplary; there can also be chosen arrangements comprising either more or else fewer measuring resistors or having different alignments of the measuring resistors. For example the two pairs of measuring resistors of the lands could also be arranged so that they form a respective side of a rectangle so that they are arranged in a rectangle. Alternatively also an arrangement in cross shape having a joint center is possible.

These measuring resistors form full bridges or temperature-compensated Wheatstone's full bridges, for example. For this purpose, two measuring resistors of a sensor can be arranged in a respective compressed or tensioned zone on the surface of the sensor.

The measuring results become exacter and more reproducible by a temperature compensation due to the circuit forming a full bridge.

FIG. 3 shows the sensor plate 1 according to FIG. 2, wherein the measuring resistors 8 have been omitted. In accordance with FIG. 3, the sensor plate 1 is a circular disk having slit-shaped weakened areas 22 which subdivide the sensor plate 1 into a central portion 19 and a marginal portion 18, said two portions being fixedly connected to each other via lands 20. In FIG. 3 it is further visible that a marginal reinforcement 17 is formed in the marginal area of the sensor plate 1 and such marginal reinforcement 17 is also visible and described in FIG. 1.

Via notches 16 screws or other fasteners are allowed to penetrate so as to fix the sensor plate 2 at an appropriate acceptance, preferably a force sensor housing.

The hole 21 provided in the middle of the sensor plate 1 as shown in FIG. 3 serves for connecting a coupling member as it is illustrated in FIG. 1, for example, with reference numeral 4. Deviating therefrom, the coupling member can also be connected to the bore 21 in such way that tensile forces are applied to the sensor plate 1, i.e. in FIG. 3 the central portion 19 would be pulled upwards while the marginal portion 18 is held stationary at the housing. This deviates from the representation according to FIG. 1, where the force F to be measured is applied to the central portion 19 as compressive force striving for pressing the central portion 19 toward the bottom area 33 of the cup-shaped housing 3.

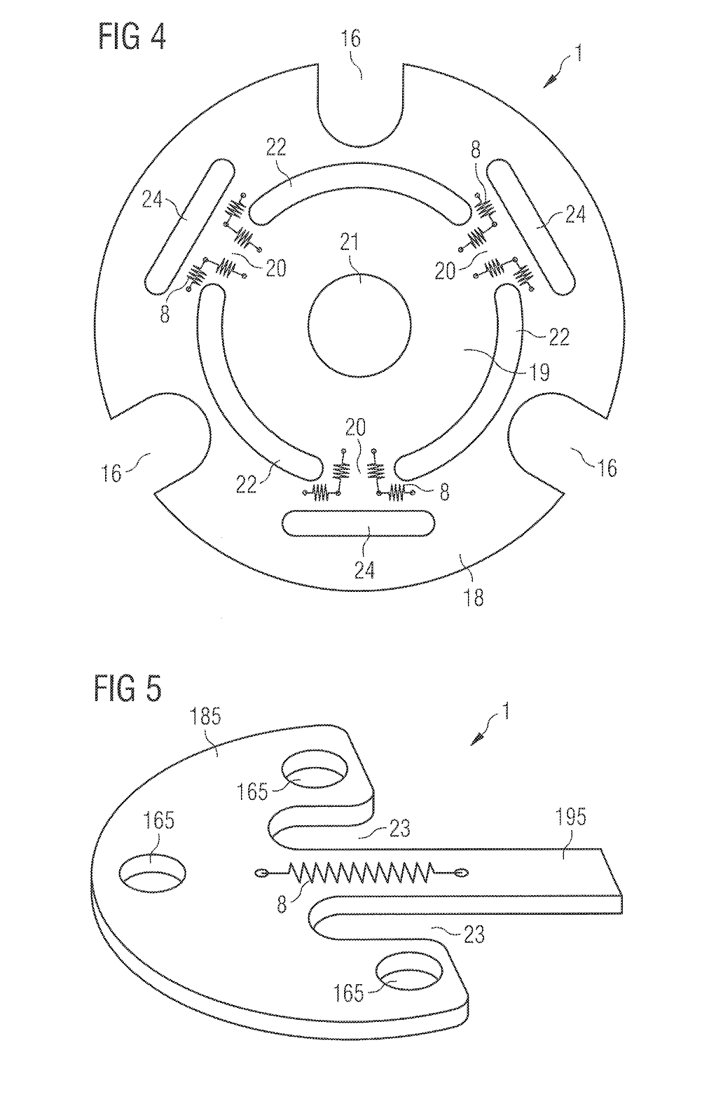

FIG. 4 shows a top view of another embodiment of a sensor plate 1. Just as the sensor plate according to FIG. 2, also this sensor plate 1 according to FIG. 4 comprises a central portion 19, a marginal portion 18, notches 16 in the marginal portion 18 as well as arc-shaped slits 22 as weakened areas which in sections are separating the central portion 1 from the marginal portion 18.

Straight slits 24 are formed between the slits 22 and the marginal portion 18 of the sensor plate 1. The slits 24 are shown as straight slits in this case, they can also be curved, however. The slits 24 are arranged to overlap an area in which a land 20 connecting the marginal portion 18 to the central portion 19 is arranged. The design of the slit 24 results in an approximately T-shaped design of the land 20 by which forces are transmitted from the central portion 19 to the marginal portion 18.

In accordance with the T-shape, measuring resistors 8 that are attached to follow approximately the bars of a T are arranged on the land 20. Considering the T-shaped land 20 as a T bar in the radial direction and a T bar normal thereto in the tangential direction, at each of the T-shaped lands 20 two measuring resistors 8 are disposed in the radial direction and two measuring resistors 8 are disposed in the tangential direction in the arrangement according to FIG. 4. Consequently, tensions in the radial direction as well as tensions in the tangential direction can be detected at the land 20 by the measuring resistors 8. The other structure of the sensor plate 1 according to FIG. 4 corresponds to that of the sensor plate according to FIGS. 2 and 3, respectively.

FIG. 5 illustrates a somewhat different embodiment for a sensor plate 1. In this case the reference numeral 185 denotes a base portion adopting a function similar to the marginal portion of a circular sensor plate 1 as described before. Bores 165 serve for fastening the base portion 185 to a housing or an acceptance not shown. Recesses 23 in the sensor plate 1 cut clear an arm 195 which, as to its function, approximately corresponds to the central portion of a circular sensor plate as explained before. A measuring resistor 8 is arranged on the arm 195 in the vicinity of the root of the arm 195 in the area of the recesses 23. One or more measuring resistors 8 can be used; in particular it is also possible to juxtapose the measuring resistors 8 in parallel on the arm 195. If the free end of the arm 195 is loaded, while the base portion 185 is fixedly held on an acceptance, the arm 195 deforms especially in the area of the recesses 23 so that a clear signal can be tapped off the measuring resistors 8 in this case.

By the arrangement according to FIG. 5 a sensor plate is suggested that can be used several times in a force sensor, in particular when the force measuring function is to be installed in a larger system so that a force or deformation can be tapped at different points of a larger assembly.

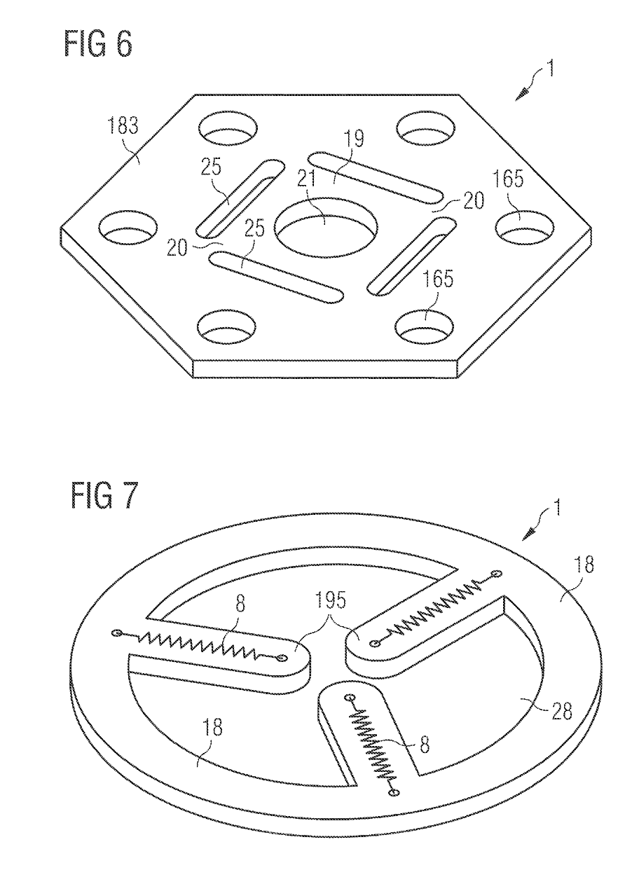

FIG. 6 illustrates a sensor plate 1 having a hexagonal form. In this case, too, the outer part of the sensor plate 1 provided with bores 165 forms a base portion 185 by which the sensor plate 1 can be fixed at an appropriate counter-piece, an acceptance or a housing (not shown). Just as the sides of a rectangle, slits 25 frame a hole 21 formed in the middle of the sensor plate 1 and being adjusted for engagement with a coupling member. Between the respective ends of the slits 25 there are formed lands 20 interconnecting the base portion 185 and the central portion 19 of the sensor plate 1. Analogously to the remarks made on the FIGS. 2 to 5, measuring resistors (not shown) are arranged in the area of and/or on the lands 20.

FIG. 7 illustrates another embodiment of a sensor plate 1 including a marginal portion 18 and arms 195 extending from the marginal portion toward the center of the circle. On the arms 195, preferably in the area of the roots thereof, measuring resistors 8 are arranged for detecting a deformation of the arms 195 vis-à-vis the marginal portion 18. The shape of the sensor plate 1 in FIG. 7 is formed by introducing a joint recess 28 into a circular disk, the large-area recess 28 leaving merely the marginal portion 18 and the arms 195 of the sensor plate material.

In a variation of the configuration according to FIG. 7 not shown here, the free ends of the arms 195 can also be merged into a hub or a piece. This case would provide three similar recesses which do not separate the arms from each other at their free end in FIG. 7, however. In this way a central portion to which the force to be measured is applied would be formed in addition to the marginal area.

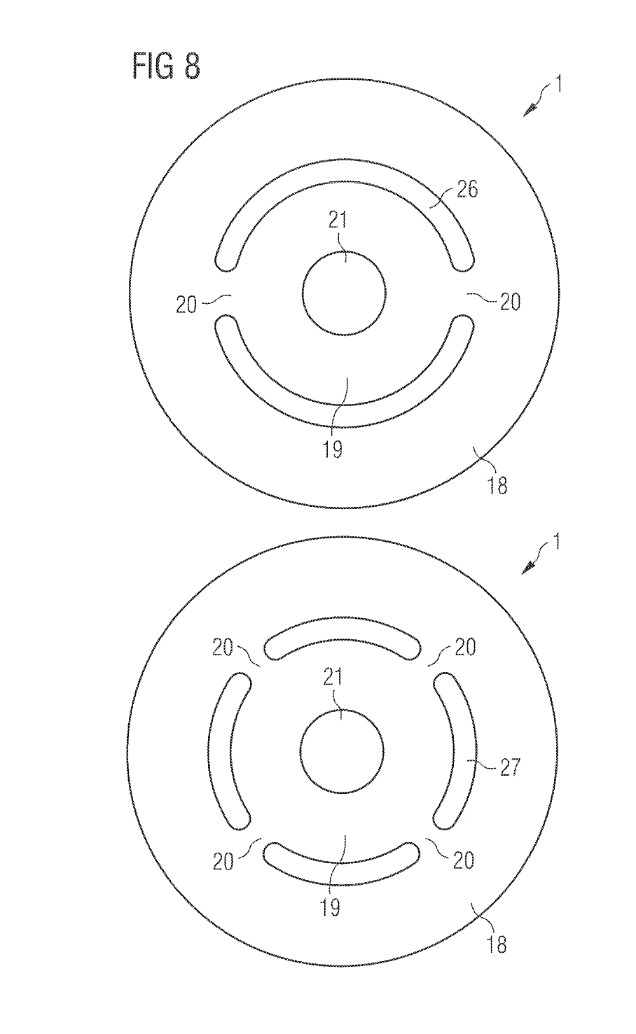

FIG. 8 schematically shows a top view of two further possible arrangements for slits and recesses 26 and 27 as weakened areas in a circular disk-shaped sensor plate 1. In the configuration according to the left-hand view in FIG. 8 two slits 26 are provided that extend in arc shape and separate the central portion 19 and the marginal portion 18 from each other in sections, wherein two lands 20 connecting these two portions are retained. The central hole 21 serves for connecting a coupling member.

In the right-hand representation of FIG. 8 a top view of an alternative embodiment of a circular disk-shaped sensor plate 1 is shown. In this case four curved slits 27 are provided for subdividing in sections the circular disk-shaped sensor plate 1 into a marginal portion 18 and a central portion 19, wherein four lands 20 are formed between the respective longitudinal ends of the slits 27 at which the central portion 19 and the marginal portion 18 are interconnected. Measuring resistors (not shown) are arranged at or in the area of the lands 20, as described in detail in the foregoing already.

In the representation according to FIG. 8 the fastening notches or fastening bores and similar details are not shown; the solutions according to the preceding figures can be adopted.

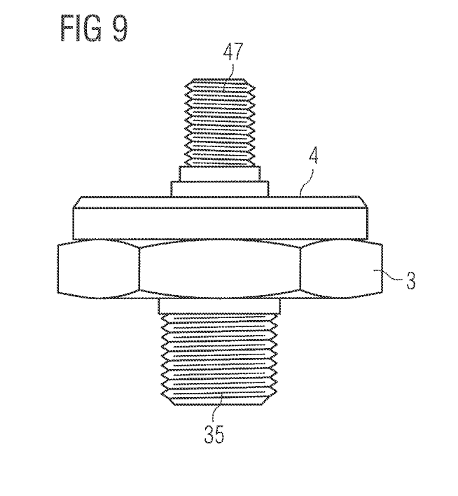

Finally FIG. 9 shows a side view of a force sensor as it appears in the completely mounted state. The cup-shaped housing 6 is provided with a hexagon head and supports a threaded extension 35 by which it can be screwed into a corresponding acceptance. Furthermore, in FIG. 9 the coupling member 4 is visible which equally includes a threaded extension 47 to which a corresponding force application portion of a device can be connected.

By an internal structure according to FIG. 1 the force sensor would detect a force loading the two threaded extensions 35 and 47 toward each other. In so doing, not only the total force can be detected, but also the direction and possibly the distribution of forces can be detected due to the different loads of the different lands each of which can be detected separately so that different force vectors as regards magnitude and direction acting between the threaded extensions 47 and 35 can be detected by the force sensor.

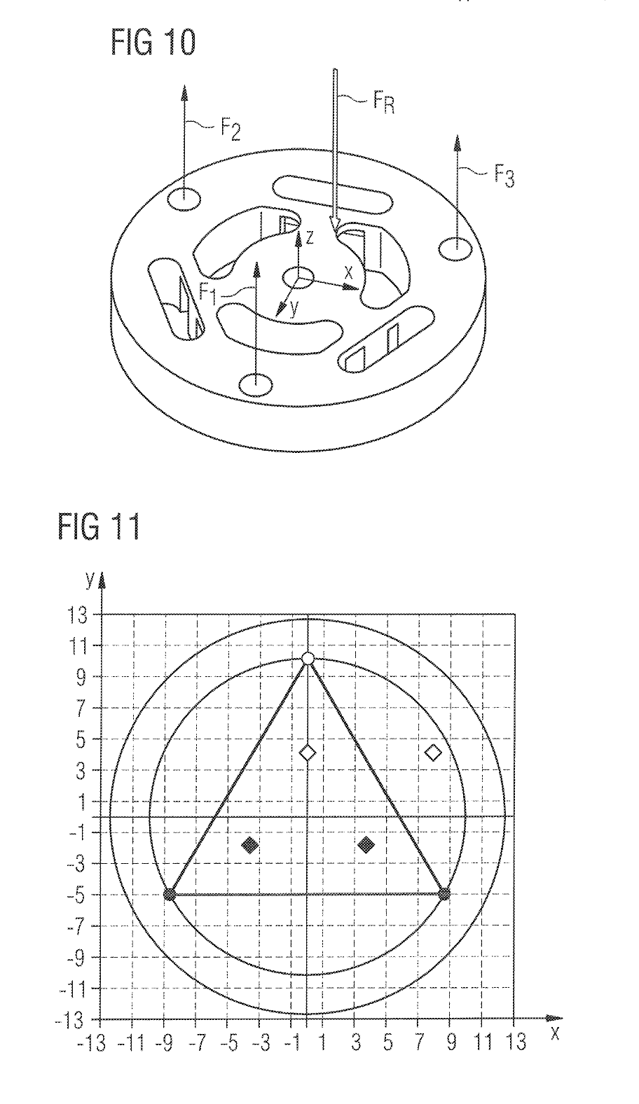

FIG. 10 shows another embodiment of the force sensor in which the sensor plate is made of comparatively thick plate material, wherein the lands interconnecting a central portion and a marginal portion of the sensor plate have a smaller thickness than the rest of the sensor plate.

Hereinafter it will be explained by way of FIGS. 10 and 11 in which way the position coordinates of a location of force application on the central portion can be determined from the readings of the sensors.

F_{R} in FIG. 10 corresponds to the axial force applied. F₁, F₂ and F₃ are the counter-forces of the deformation member acting on the three fastening points 16. The position of the location of force application is expressed in Cartesian coordinates xₛ, yₛ with the center of the pressure plate being the origin of coordinates. Equilibrium of forces is formed on the following boundary conditions:

$$\begin{matrix}{\sum }_{i} {F}_{iz} = 0 & ( 1 ) \\ {\sum }_{i} {M}_{ix} = 0 & ( 2 ) \\ {\sum }_{i} {M}_{iy} = 0 , & ( 3 )\end{matrix}$$

wherein Mᵢₓ and M_{iy} are the moments in the x direction and in the y direction.

By way of the moment equilibriums, xₛ and yₛ can be determined as follows:

$$\begin{matrix}{x}_{s} = \frac{{F}_{1} \cdot 0 + {F}_{2} \cdot cos ( α ) \cdot r - {F}_{3} \cdot cos ( α ) \cdot r}{{F}_{1} + {F}_{2} + {F}_{3}} & ( 4 ) \\ {y}_{s} = \frac{{F}_{1} \cdot r - {F}_{2} \cdot sin ( α ) \cdot r - {F}_{3} \cdot sin ( α ) \cdot r}{{F}_{1} + {F}_{2} + {F}_{3}} & ( 5 )\end{matrix}$$

As is evident from FIG. 11, in the arrangement of the sensors at respective angles of 120° according to the shown embodiment and in the shown position of the coordinate system the angle α is equal to 30°.

The distance r and the angle α are constant. Since the partial forces are proportional to the measured readings

$$\frac{m V}{V} ,$$

the equation for determining the location can also be used directly with the three measured readings U₁, U₂ and U₃ without determining the forces before.

As those skilled in the art will easily find out, the three bending portions can also be arranged at other, possibly also different mutual angles and distances from the origin of coordinates. The formulae (4) and (5) have to be appropriately adapted with three angles α, β and γ and three distances r₁, r₂ and r₃ having to be used, where appropriate.

In this way, the coordinates of the location of force application on the pressure plate can be determined from the three readings and they can then be displayed on a display device.

There has been described in detail a sensor plate including various recesses so as to show specific local deformations under load. The weakened areas have been described as recesses; however, also a local material abrasion can be provided to specifically weaken the sensor plate at selected positions.

A sensor plate is preferably formed of stainless steel and the measuring resistors are applied by thin-film technique. The weakened areas can be produced by laser cutting, water-jet cutting and, as a matter of course, by mechanical tensioning techniques. It is also possible to initiate a well-directed material abrasion on the sensor plate by etching techniques or (spark) erosion techniques so as to reduce the thickness of or break the same there in a well-directed manner.

The evaluation circuit preferably can have a compact design in the form of integrated circuits and can be encapsulated in a fluid-tight manner.

For transmitting signals from the evaluation circuit standardized reports are known which can be employed in this case.

Preferably, the electrical connection of the evaluation circuit can be formed in combination with a screwing set-up for the threaded extensions at the force sensor, but also separate plug connectors can be provided at the periphery of the force sensor.

1. A force sensor for measuring forces comprising:
a sensor plate at which at least one measuring resistor is arranged by which deformations of the sensor plate can be detected as a result of forces to be measured,
wherein the sensor plate has at least one local weakened area influencing the deformation behavior of the sensor plate.

2. The force sensor according to claim 1, wherein the at least one measuring resistor is arranged at a deforming portion of the sensor plate which is different from the weakened area.

3. The force sensor according to claim 1, wherein by the at least one weakened area sensor plate portions separated from each other at least in sections are interconnected by at least one land operatively connected to the at least one measuring resistor on the sensor plate.

4. The force sensor according to claim 3, wherein the at least one measuring resistor is arranged at and/or adjacent to the land.

5. The force sensor according to claim 1, wherein the weakened area is a plate cut-out and/or a recess in the sensor plate and/or the land is a non-weakened plate portion.

6. The force sensor according to claim 1, wherein the forces to be measured are opposite forces applied to areas of application of the sensor plate, wherein the local weakened area is arranged between areas of application of the opposite forces.

7. The force sensor according to claim 6, wherein the sensor plate is subdivided by the at least one weakened area into an outer portion and a central portion connected by at least one land and forming the areas of application for the forces to be measured, wherein the at least one measuring resistor is arranged on the land or in the base area of the land.

8. The force sensor according to claim 7, wherein the outer portion and/or the central portion is/are provided with additional weakened areas.

9. The force sensor according to claim 8, wherein the at least two weakened areas intersect a straight line extending from the middle of the sensor plate to its outer rim.

10. The force sensor according to claim 7, wherein the sensor plate is supported on its outer portion and the central portion is adapted to be connected to coupling members for coupling the forces to be measured.

11. The force sensor according to claim 1, wherein the sensor plate is a circular disk.

12. The force sensor according to claim 6, wherein the sensor plate comprises a base portion and a projecting portion extending therefrom and being restricted by weakened areas, wherein on the projecting portion the at least one measuring resistor is arranged and the portions of application for the forces to be measured are formed by the base portion and the end of the projecting portion facing away from the base portion.

13. The force sensor according to claim 12, wherein the base portion is a circular ring from which plural projecting portions having measuring resistors thereon extend spoke-like to the center of the circular ring and end there or are connected hub-like to form a joint portion of application.

14. The force sensor according to claim 1, wherein plural measuring resistors are provided which are connected especially in the form of bridge circuits and which are connected to an evaluation circuit.

15. The force sensor according to claim 14, wherein the force, the direction of force and the location of force application related to the center of the sensor plate are separately evaluated.

16. The force sensor according to claim 1, wherein the weakened area of the sensor plate is defined so that forces within the range of from 10 N to 1000 N can be detected.

17. The force sensor according to claim 1, wherein the sensor plate and/or a housing receiving the sensor plate and/or a coupling member is/are made of stainless steel.

18. The force sensor according to claim 1, wherein the measuring resistors arranged at the sensor plate are resistors applied by thin-film technique.

19. A method for manufacturing a force sensor for measuring forces comprising a sensor plate at which at least one measuring resistor is arranged by which deformations of the sensor plate can be detected due to forces to be measured, wherein the sensor plate has at least one weakened area influencing the deformation behavior of the sensor plate, the method comprising:
introducing the weakened area into the sensor plate after the sensor plate has been provided with the at least one measuring resistor.

20. A method for determining a force vector by means of a plate-shaped sensor comprising a number of weakened areas and plural measuring resistors arranged in connection with the weakened areas, in particular by means of a force sensor according to claim 1, wherein the individual signals of the measuring resistors are offset against each other and the amount and the direction or the amount and the coupling point of the force vector are determined and output from the individual signals.

21. The method for determining a force vector according to claim 20, wherein the amount and the direction or the amount and the coupling point of the force vector are determined via vector addition of the individual signals or by way of a matrix equation based on the individual measuring resistor positions in a cylinder coordinate system and the related individual signals.
